(19) United States
(12) Patent Application Publication
(10) Pub. No.: US 2011/0071446 A1
(43) Pub. Date: Mar. 24, 2011

(54) MASSAGE BALL AND METHOD OF USING SAME

(76) Inventor: Stuart Citrin, Hillsborough, CA (US)

(21) Appl. No.: 12/566,635

(22) Filed: Sep. 24, 2009

(51) Int. Cl. A61H 7/00

(52) U.S. Cl. 601/135

(57) ABSTRACT

The present invention describes a device used for deep-tissue massage and in particular for trigger point therapy. The invention further describes methods of providing deep-tissue massage or trigger point therapy. The deep-tissue massage or trigger point therapy devices and methods disclosed herein can be used or performed on oneself or with the assistance of another.

### FIELD OF THE INVENTION

This invention relates to an apparatus and method of using the apparatus to perform deep-tissue massage and/or trigger point therapy on an afflicted part of the body, creating increased oxygen and blood flow to the area.

### BACKGROUND OF THE INVENTION

Millions of Americans experience chronic back pain. In fact, between 80% and 90% of all people will experience chronic back pain at some point in their lives. According to the Mayo Clinic's contemporaneous website posting, back pain is one of the most common reasons why people go to the doctor or miss work. The human back is an intricate structure composed of bones, muscles, ligaments, tendons and disks, which are cartilage-like pads that act as cushions between the segments of your spine. Back pain can arise from problems with any of these component parts. The most common type of back pain occurs from strained muscles and ligaments due to such things as improper or heavy lifting, sudden awkward movement, or a muscle spasm.

In terms of treating back pain, common treatments include over the counter medication combined with bed rest. If not treatable at home, medical doctors will often treat the patient with prescription medications, sometimes combined with physical therapy. For mild to moderate back pain, medications can range from non-steroidal, anti-inflammatory drugs or muscle relaxants. More severe back pain might be treated with narcotics, such as codeine or hydrocodone for a short period of time, under close supervision by a doctor. Moreover, low doses of certain types of antidepressants—particularly tricyclic antidepressants, such as amitriptyline—have been shown to relieve chronic back pain, independent of their effect on depression.

If an individual is treated by seeks physical therapy, the physical therapist can apply a variety of treatments, such as heat, ice, ultrasound, electrical stimulation and muscle-release techniques, to the patient's back muscles and soft tissues to reduce pain. As pain improves, the therapist can teach the patient specific exercises to increase his/her flexibility, strengthen his/her back and abdominal muscles, and improve his/her posture. Regular use of these techniques will help prevent pain from coming back.

Seeking medical help for lower back pain can be expensive and time consuming. In addition, many people, given the option, would rather obtain relief from pain without medication. One such technique used for diminishing back pain, and pain elsewhere in the body instead of taking medication, is the technique of applying pressure to a “trigger point” in order to release a contraction, thereby reducing the pain caused by the trigger point. The term “trigger point” was coined in 1924 by Dr. Janet Travell. A “trigger point,” which will be discussed more fully below, is a knot in a muscle fiber consisting of a mass of microscopic units (sarcomeres) in a state of constant contraction.

When sufficient pressure is applied to a trigger point, it releases the contraction. This can be achieved in physical therapy, in deep-tissue massage therapy, or through self-administration. The most obvious and instantaneous benefit of trigger point therapy is pain relief, but there are many more benefits that can be achieved over time with trigger point therapy, including the following: increased range of motion, more flexibility, better circulation, reduced stiffness, and improved quality of life. While these benefits can be realized by seeking professional help, either via physical therapy or massage therapy, it would be much more cost effective and convenient to be able to realize these benefits without incurring the costs, both monetary and in time, of seeking professional help. There is thus a need for an inexpensive means of gaining the benefits of trigger point therapy.

### SUMMARY OF THE INVENTION

The present invention describes a device and method for deep-tissue massage. The device and methods are particularly suited for trigger point therapy, which can result in reduced pain and overall improved health.

### BRIEF DESCRIPTION OF THE DRAWINGS

FIG. 1 shows a front elevational view of a device for administering self-massage.

FIG. 2 is a sectional view of an alternate embodiment having a threaded seam.

FIG. 3 is front elevational view of an alternate embodiment having handgrips.

### DETAILED DESCRIPTION OF THE INVENTION

The invention described herein is not limited in its application to the details of construction and the arrangements of the components set forth in the following description or illustrations in the accompanying figures. The invention is capable of other embodiments and of being practiced or carried out in various ways. The phraseology and terminology used herein is for the purpose of description and should not be regarded as limiting. The use of “including” and “comprising” and variations thereof is meant to encompass the items listed thereafter and equivalents thereof as well as additional items. The use of “consisting of” and variations thereof herein is meant to encompass only the items listed thereafter. The use of letters to identify steps of a method or process is simply for identification and is not meant to indicate that the steps should be performed in a particular order. Moreover, the use of gender specific pronouns is not meant to exclude either gender from the benefits provided by the present invention.

Turning to the present invention, the concepts described herein provide a method and apparatus for obtaining relief from pain by applying pressure to a trigger point. Although the back is one of the most common areas where individuals experience pain, the present invention provides a method and apparatus for relief from pain in any trigger point located in an individual's body. Trigger point therapy has been shown to be useful for treating fibromyalgia, chronic myofascial pain syndrome, low back pain, carpel tunnel syndrome, tennis elbow, neck and jaw pain, shoulder pain, arthritis, headaches, knee pain, foot pain, joint and muscle aches, sports injuries, and repetitive strain injuries.

According to “The Trigger Point Therapy Workbook,” Second Edition, by Clair Davies, NCTMB, “the place where contraction occurs in muscle fiber is a microscopic unit called a sarcomere. Millions of sarcomeres have to contract in your muscles to make even the smallest movement. A trigger point exists when over-stimulated sarcomeres become unable to release their contracted state . . . . Normally, sarcomeres act like tiny pumps, contracting and releasing to circulate blood through the capillaries that supply their metabolic needs. When sarcomeres in a trigger point hold their contraction, blood flow essentially stops in the immediate area. The resulting oxygen starvation and accumulation of the waste products of metabolism irritate the trigger point. The trigger point responds to this emergency by sending out pain signals until the brain institutes a policy of rest for the muscle.” Id. at 20-21. Most people stop using the muscle, which then begins to shorten and tighten up, causing pain.

Those skilled in the art recommend, among other treatment modalities, the use of a tennis ball against a wall or floor as a means of applying pressure to a trigger point. Applying pressure to a trigger point allows blood to flow to that point, which initiates the healing process and releases the contraction. Once the contraction is released, an individual begins to experience relief from pain. Some professionals recommend applying deep pressure to trigger points six or more times per day. In order for an individual to be able to apply deep pressure to what may be a hard to reach spot six or more times a day, he or she must have access to a cost effective and reliable means of treatment. Scheduling six massage therapy or physical therapy appointments per day would not only be economically infeasible for most, but would be incredible disruptive to one's schedule.

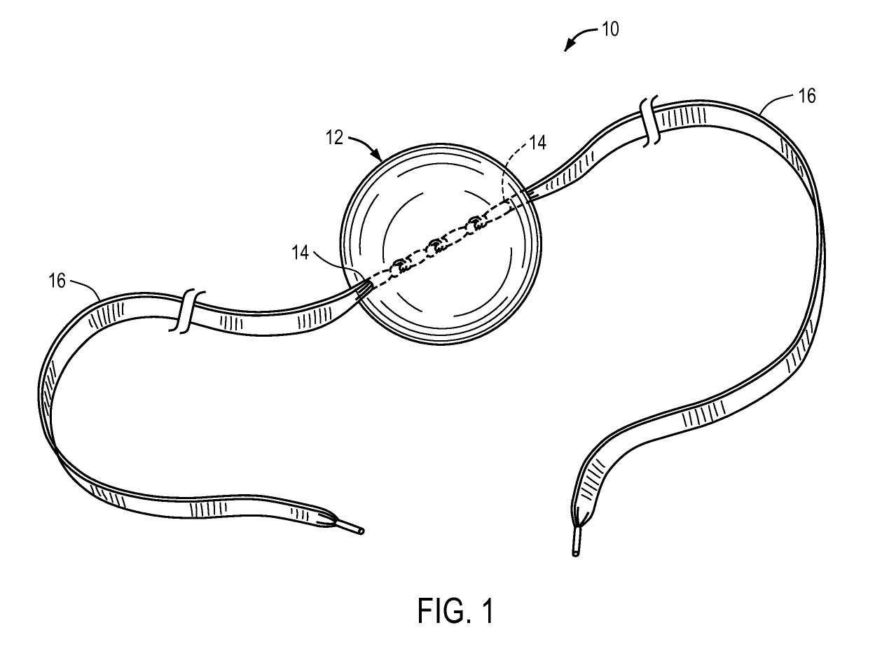

The present invention provides a cost effective and easy to use method and apparatus for trigger point therapy. Turning to present invention, FIG. 1 depicts an apparatus used to efficiently and reliably isolate and treat a trigger point. There have been many massage devices developed over time, but a limited number of these can be used for trigger point therapy. In order for a trigger point therapy device to be effective, it must provide sufficient pressure to a specific location. The device 10 of FIG. 1, comprises a ball 12 having two holes 14 and a gripping member 16 used by an individual to administer trigger point therapy. The ball 12 can vary in its diameter and its stiffness. The stiffer the ball is, the more pressure will be applied to a trigger point when an individual uses the device 10. Some individuals may prefer lighter trigger point pressure, which could be achieved by using a soft, rubber, bouncy ball. For those individuals seeking more pressure for trigger point therapy, the ball 12 could be as hard as a baseball or field hockey ball. In terms of diameter, the ball 12 could, by way of example, and not to exclude larger or smaller balls, range in diameter from 20 mm to 120 mm.

The ball 12 may in alternate embodiments have additional properties that facilitate heating or cooling of the ball 12 prior to trigger point therapy. In one embodiment, the ball 12 may be made of a material that retains cold for a longer period of time than a baseball or similar sports ball. In this embodiment, a user could place the ball 12 in the freezer prior to use. An alternate embodiment could allow the insertion of water within the ball 12 either through an opening in the exterior of the ball 12 or by unscrewing the ball and placing a sealed water pack inside of the ball. Once the water has been added, the user could place the ball 12 in the freezer to create an ice pack internal to the ball 12. Cold trigger point therapy may be recommended for those individuals experiencing swelling in, or around, a trigger point.

The corollary of cold treatments could also be achieved in an alternate embodiment of the ball 12 wherein the ball 12 could be designed to retain heat, for example after being heated in a microwave. In this embodiment, the exterior of the ball 12 could be chosen for its heat retention properties. The ball 12 could be heated in a variety of ways known to those skilled in the art, for example, microwave, insertion into warm or hot water, placement within an oven and so on. Moreover, an alternate embodiment could be constructed to allow insertion of a gel pack interior to the ball 12 such that the gel pack on its own or after insertion into the ball 12 could be heated in a microwave, hot water, or similar heating mechanism, thereby facilitating trigger point therapy with the use of a heated ball 12.

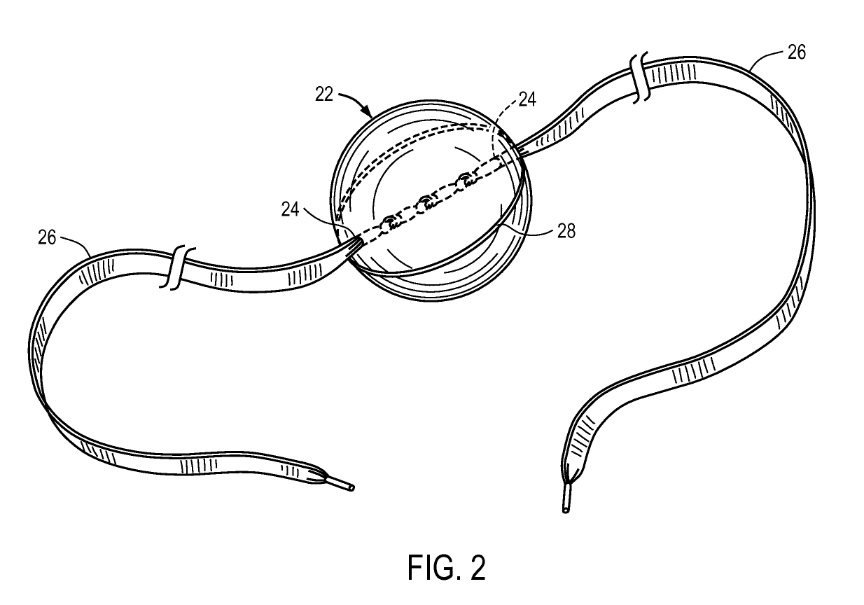

For these embodiments, where a user may need to place something inside of the ball 12, the ball could have a threaded seam that would enable a user to open up the ball 12 and place a water packet, heat gel packet, vibrating device or similar device that would enhance the use of the ball 12 as a hot, cold, or vibrating trigger point therapy device. FIG. 2 shows a ball 22, also comprising two holes 24 and a gripping member 26. The ball 22 of this embodiment also includes a threaded center seam 28 enabling the insertion of water, a water packet, a heat gel pack, or vibrating device. Those skilled in the art will recognize that the threaded seam 28 could be placed anywhere on the ball 22 without changing the functionality of the invention.

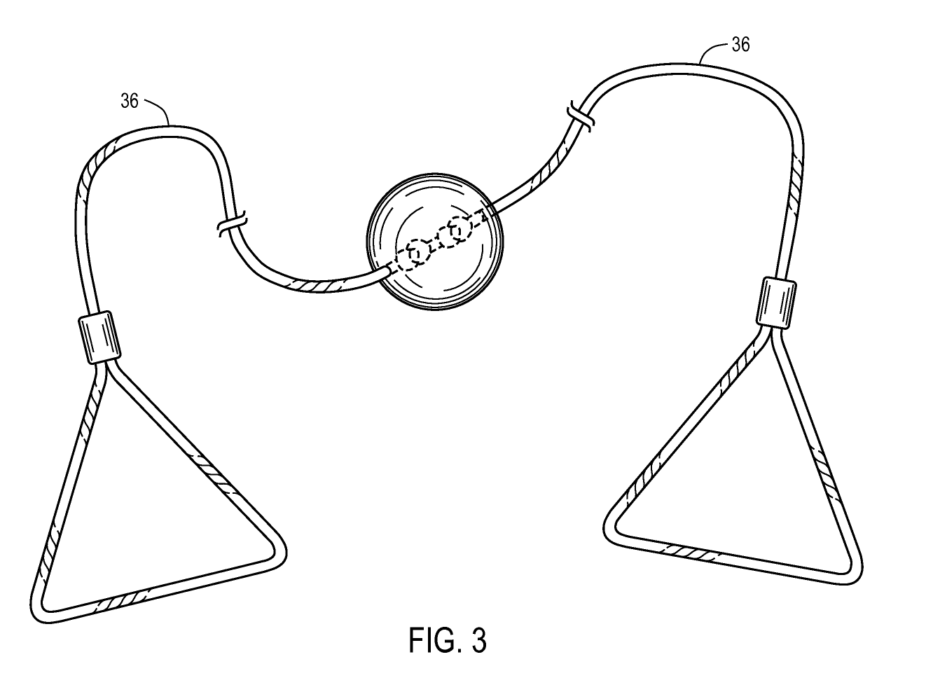

The gripping member 16 depicted in FIG. 1 can be a variety of materials, shapes, and lengths. By way of example, the gripping member 16 could be a shoelace protruding from each of the holes 14. Its length could be approximately two feet. Similarly, and as shown in FIG. 3, an alternate embodiment could comprise a gripping member 36 with handles, which would facilitate ease of use. The gripping member 36 could be a heavy-duty climbing rope with handles on either end. The gripping member could also be any type of rope, cable, bungee cord, string, nylon material, plastic, wooden handle, hard plastic or metal handle, elastic material, and similar materials known to those skilled in the art, with or without handles. In FIGS. 1-3, the gripping member is shown as a contiguous length of rope or shoe lace. Those skilled in the art will recognize that the gripping member could be segmented without compromising the functionality of the present invention. Similarly, the embodiment of FIG. 3 could include a threaded seam, similar to that depicted in FIG. 2, or not, as those skilled in the art would be aware of.

One purpose of the gripping member 16 is to allow the user of the device 10 to be able to control the location of the ball 12 in such a way so as to achieve the appropriate amount of pressure on a trigger point. The length of the gripping member can be as short as five inches and as long as several feet. The length can be tailored to body size. For children, a shorter length gripping member 16 may be useful, whereas for an adult, having too short of a gripping member 16 may result in the adult not being able to reach certain spots in the back, or having his or her hands be too large for the gripping member 16.

The present invention lends itself to a method of using the above-described device to alleviate pain or for self-massage. In alternate embodiments, the present invention can be used as a method of massage. A user of the inventive device 10 could, for example, place the ball 12 on an area of the body for which he or she desires massage. The user could enhance the amount of pressure to the massage point by leaning against a wall, floor, chair, bed, or similar rigid surface. In this way, the user could massage a point of tension is his or her body. The gripping member 16 facilitates accurate placement of the inventive device 10.

In addition, although only the figures and discussion of the embodiments of the present invention have focused on the present invention being comprised of a single ball or a method of alleviating pain using a single ball, those skilled in the art will recognize that the methods and devices disclosed herein in could provide relief to some people if they chose to use more than one ball as described in the preceding embodiments.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the widest scope consistent with the principles and novel features herein disclosed.

I claim:

1. A device for administering massage comprising:
a ball having two holes, which penetrate through the surface of the ball, wherein the two holes create a cavity through which a gripping member can be interiorly placed through the ball.

2. A device for administering massage comprising:
a ball having two holes, which penetrate through the surface of the ball, wherein the two holes create a cavity; and
means for gripping the ball in order to facilitate self-massage.

3. The device of claim 1, wherein the gripping member is selected from the group consisting of: a rope, a string, a shoe lace, a bungee cord, a cable, nylon, a wooden handle, a plastic handle, or a metal handle.

4. The device of claim 1 further comprising a threaded seam configured for opening and closing.

5. A method for massaging a portion of the body comprising the steps of:
(a) placing a ball on a desired portion of the body;
(b) using a gripping member to locate a spot on the body for which the user desires massage; and
(c) applying pressure to the spot on the body for which the user desires massage.

6. The method of claim 5 further comprising the massage being trigger point therapy.

7. The method of claim 5 further comprising placing the ball between the desired portion of the body and a surface.

8. The method of claim 7 wherein the surface is chosen from the group consisting of: a wall, a chair, a table, a floor, a couch, a bed, a love seat, or a seat.
